(19) United States
(12) Patent Application Publication
(10) Pub. No.: US 2024/0174941 A1
(43) Pub. Date: May 30, 2024

(54) Bearings, Conductive Grease, and Variable Frequency Drive Systems

(71) Applicant: Baylor University, WACO, TX (US)

(72) Inventors: Annette VON JOUANNE, Waco, TX (US); Alex YOKOCHI, Waco, TX (US); Madeline STEPHENS, Waco, TX (US)

(73) Assignee: Baylor University, Waco, TX (US)

(21) Appl. No.: 18/310,088

(22) Filed: May 1, 2023

Related U.S. Application Data
(60) Provisional application No. 63/337,270, filed on May 2, 2022.

(51) Int. Cl. C10M 169/02; C10M 107/02; C10M 113/02; F16C 33/66; C10N 20/06; C10N 40/02; C10N 50/10

(52) U.S. Cl. CPC C10M 169/02; C10M 107/02; C10M 113/02; F16C 33/6633; C10M 2201/0416; C10M 2205/0206; C10N 2020/06; C10N 2040/02; C10N 2050/10; F16C 2380/26

(57) ABSTRACT

The present disclosure provides a formulated conductive grease for an associated bearing that can be used in a drive system, such as a variable frequency drive system for motors having a formulation sufficient to reduce the voltage build up that causes damaging electric discharge machining (“EDM”) on rotational bearing supported surfaces, such as inner and outer races, while still maintaining a grease composition suitable for bearing long life at operational temperatures. The higher conductivity of the inventive grease results in lowering of the threshold voltage of pulse discharges, which consequently decreases the energy release in each pulse and the resulting bearing temperatures, avoiding bearing damage. The disclosure further provides a bearing lifetime prediction model given typical discharge conditions from both Si and SiC inverters using a bearing state of health (SOH) metric.

### CROSS REFERENCE TO RELATED APPLICATIONS

This application claims the benefit of US. Provisional Application Ser. No. 63/337,270, entitled “Bearings Assembly with Conductive Grease for Electrical Systems”, filed May 2, 2022, which is incorporated herein by reference.

### STATEMENT REGARDING FEDERALLY SPONSORED RESEARCH OR DEVELOPMENT

This invention was made with government support under N00014-20-1-2193 awarded by the Office of Naval Research (ONR). The government has certain rights in the invention.”

### REFERENCE TO APPENDIX

Not applicable

### BACKGROUND OF THE INVENTION

### Field of the Invention

The disclosure generally relates to reducing damaging electrical energy discharges within bearings. Specifically, the disclosure relates to bearings, including motor bearings, having conductive grease of a composition sufficient to reduce the energy in electric discharges through the bearing that occur during operation, such as in motors driven by variable frequency drive systems.

### Description of the Related Art

Electrical controllers for motors and other electrical machinery can cause an electrical voltage to build up on the motor shaft due to electrostatic energy stored in motor capacitances. When the motor shaft voltage exceeds the dielectric capability of the bearing grease a potentially damaging bearing current is discharged through the bearing. For example, variable frequency drives (VFDs) in the W to tens of MW range are employed in a variety of applications worldwide including pumps, fans, compressors, etc., as well as for motor drives in motion control and electrified transportation. Si-based power semiconductor switching devices have been widely employed in VFDs using high dv/dt pulse-width modulated (PWM) inverters. The high dv/dt PWM inverter output pulses have adverse effects on the system components and the machines they are driving due to insulation stresses and damaging motor bearing currents resulting from common-mode (CM) voltages and shaft voltages. As a result, specifically to address bearing currents in Si-based VFDs, several mitigation techniques have been suggested to prevent bearing damage including: filters, reducing the CM voltage through additional switches, improved modulation strategies, insulating the bearings, and using a brush to ground the rotor shaft or capacitive coupling shunting.

Advanced wide band gap (WBG) GaN, and more commonly SiC-based motor drives enable much higher switching frequencies, efficiencies, and power densities compared with traditional Si-based power electronics. From a device efficiency point of view, it is highly desirable to have high dv/dt to minimize the turn-on/turn-off times corresponding to the switching losses. SiC and GaN device switching frequencies in the few hundred kHz to MHz range with higher dv/dt and di/dt rates of voltage or current change (“slew rates”) raise new challenges including exacerbating the CM voltage and dv/dt issues.

This is a need to reduce premature failure of bearings caused by voltage on the bearing.

### BRIEF SUMMARY OF THE INVENTION

The present disclosure provides a formulated conductive grease for an associated bearing that can be used in a motor-drive system, such as a variable frequency drive system for motors, having a formulation sufficient to reduce the voltage build up that causes damaging electric discharge machining (“EDM”) on rotational bearing supported surfaces, such as inner and outer races, while still maintaining a grease composition suitable for bearing long life at operational temperatures. The higher conductivity of the inventive grease results in lowering of the threshold voltage of pulse discharges, which consequently decreases the energy release in each pulse and the resulting bearing temperatures, avoiding bearing damage. The disclosure can also provide a bearing lifetime prediction model given typical discharge conditions from both Si and SiC inverters using a bearing state of health (SOH) metric.

The disclosure provides a bearing comprising: an inner race; an outer race; and a conductive grease disposed at least between the races and formulated to lower electric discharge energy between the inner race and outer race to a value equal to or below 34 nanojoules sufficiently to avoid damaging the inner race and outer race.

The disclosure also provides a conductive grease comprising graphene nanoplatelets.

The disclosure further provides a motor comprising a bearing, the bearing comprising a conductive grease formulated to lower electric discharge energy between an inner race and outer race of the bearing to a value equal to or below 34 nanojoules sufficiently to avoid damaging the inner race and outer race.

The disclosure provides a system compromising a motor and at least one device coupled to the motor, wherein at least a portion of the device is configured to be rotated by the motor, and wherein the motor comprises a bearing comprising a conductive grease formulated to lower electric discharge energy between an inner race and outer race of the bearing to a value equal to or below 34 nanojoules sufficiently to avoid damaging the inner race and outer race.

### BRIEF DESCRIPTION OF THE SEVERAL VIEWS OF THE DRAWINGS

FIG. 1 is a known chart of ISO 10816-1 standard that contains general guidelines for machine vibration measurements used as a metric in the analysis described in this disclosure of the invention.

FIG. 2 is an illustrative diagram of a bearing containing a grease as described in the disclosure.

FIG. 3 is an illustrative diagram of a motor or generator with a bearing of FIG. 2.

FIG. 4 is an illustrative diagram of a system having a motor or generator of FIG. 3 coupled to a rotatable device and a stationary device.

FIG. 5 is an illustrative 3D temperature model of bearing electrical discharge used in generating and analyzing results in the disclosure.

FIG. 6 is an illustrative graph of experimental film thickness of bearing grease relative to time at different rotational speeds.

FIG. 7 is an illustrative graph of an input energy graph for a 5V discharge modeled in PSpice with an inset plot that shows a 0-100 ns region magnified to emphasize an initial electric discharge.

FIG. 8 is a simulated energy graph based on a 5V discharge in PSpice.

FIG. 9 is an illustrative diagram showing the location of a heat indicator probes about a central axis of rotation with a spacing of 0.1 μm.

FIG. 10 is an illustrative graph of calculated maximum temperatures at a depth of 0.02 μm into the steel for 5-10V with a discharge radius of 0.4 μm and a grease thickness of 0.35 μm.

FIG. 11A is an illustrative temperature profile of a steel/grease interface during the first 0.15 us of 5V runs with a discharge radii of 0.4 μm and a grease thickness of 0.35 μm.

FIG. 11B is an illustrative temperature profile of a steel/grease interface during the first 0.15 us of 7.5V runs with a discharge radii of 0.4 μm and a grease thickness of 0.35 μm.

FIG. 11C is an illustrative temperature profile of a steel/grease interface during the first 0.15 us of 10V runs with a discharge radii of 0.4 μm and a grease thickness of 0.35 μm.

FIG. 12 is an illustrative diagram of a motor modification for bearing current measurement.

FIG. 13 is an illustrative diagram showing bearing testbed circuitry to control the amplitude of discharge that a bearing experiences.

FIG. 14 is a graph of experimental shaft voltage and bearing current discharge measurements on the bearing testbed for a total of 10V, 400 mA test for two divisions.

FIG. 15A is a graph of experimental Si shaft voltage (top—line 1) and bearing current (bottom—line 2) max peak to peak (“p-p”) 28.8V at 270 mA.

FIG. 15B is a graph of experimental SiC shaft voltage (top) and bearing current (bottom) max p-p 36.8V at 400 mA.

FIG. 15C is a graph of experimental Si shaft voltage (top) and bearing current (bottom) with conducting grease.

FIG. 16A is a graph of experimental shaft voltage (top—line 1) and bearing current (bottom—line 2) for a fully loaded 460V 5 hp motor driven by a SiC-based inverter for normal grease.

FIG. 16B is a graph of experimental shaft voltage (top) and bearing current (bottom) for a fully loaded 460V 5 hp motor driven by a SiC-based inverter for conducting grease.

FIG. 16C is a graph of experimental shaft voltage (top) and bearing current (bottom) for a fully loaded 460V 5 hp motor driven by a SiC-based inverter for conducting grease modified with graphene nanoplatelets.

FIG. 17 includes the commercially available conductive greases and results of testing as to whether they meet the threshold levels that are needed to avoid the EDM damage.

FIG. 18 includes modified commercially available conductive greases according to the teachings herein and their response to meeting the threshold levels that are needed to avoid the damage.

FIG. 19 is a summary chart of experimental compositions in forming low discharge energy conductive greases.

FIG. 20 is a chart of cone penetration and NLGI grades for custom and selected conductive greases.

FIG. 21 is a chart of experimentally measured conductive grease bearing capacitances and conductivities at 1800 rpm operational speed.

FIG. 22A is a chart of experimental discharge energies relative to bearing temperature for the tested greases in FIGS. 16 and 17.

FIG. 22B is an enlarged scale of a lower portion of the chart of FIG. 18A.

FIG. 23 is a graph of plotted data of the calculated volume of the damage hemisphere Vₕ vs. the discharge energy dₑ.

FIG. 24 is a graph of plotted data of the observed number of discharges to failure vs. dₑ^{2/3}.

FIG. 25 is a graph of bearing SOH lifetime projections for the Si and SiC inverter at various motor load points of the number of discharges to failure and a motor load with a best fit curve.

FIG. 26 is a chart of average EDM rates for experiments conducted with standard deviation error bars included.

### DETAILED DESCRIPTION

The Figures described above and the written description of specific structures and functions below are not presented to limit the scope of what Applicant has invented or the scope of the appended claims. Rather, the Figures and written description are provided to teach any person skilled in the art to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present disclosure will require numerous implementation-specific decisions to achieve the developer's ultimate goal for the commercial embodiment. Such implementation-specific decisions may include, and likely are not limited to, compliance with system-related, business-related, government-related, and other constraints, which may vary by specific implementation or location, or with time. While a developer's efforts might be complex and time-consuming in an absolute sense, such efforts would be, nevertheless, a routine undertaking for those of ordinary skill in this art having benefit of this disclosure. It must be understood that the inventions disclosed and taught herein are susceptible to numerous and various modifications and alternative forms. The use of a singular term, such as, but not limited to, “a,” is not intended as limiting of the number of items. Further, the various methods and embodiments of the system can be included in combination with each other to produce variations of the disclosed methods and embodiments. Discussion of singular elements can include plural elements and vice-versa. References to at least one item may include one or more items. Also, various aspects of the embodiments could be used in conjunction with each other to accomplish the understood goals of the disclosure. Unless the context requires otherwise, the term “comprise” or variations such as “comprises” or “comprising,” should be understood to imply the inclusion of at least the stated element or step or group of elements or steps or equivalents thereof, and not the exclusion of a greater numerical quantity or any other element or step or group of elements or steps or equivalents thereof. The term “coupled,” “coupling,” “coupler,” and like terms are used broadly herein and may include any method or device for securing, binding, bonding, fastening, attaching, joining, inserting therein, forming thereon or therein, communicating, or otherwise associating, for example, mechanically, magnetically, electrically, chemically, operably, directly or indirectly with intermediate elements, one or more pieces of members together and may further include without limitation integrally forming one functional member with another in a unity fashion. The coupling may occur in any direction, including rotationally. The device or system may be used in a number of directions and orientations. The order of steps can occur in a variety of sequences unless otherwise specifically limited. The various steps described herein can be combined with other steps, interlineated with the stated steps, and/or split into multiple steps. Some elements are nominated by a device name for simplicity and would be understood to include a system or a section, such as a controller would encompass a processor and a system of related components that are known to those with ordinary skill in the art and may not be specifically described. Various examples are provided in the description and figures that perform various functions and are non-limiting in shape, size, description, but serve as illustrative structures that can be varied as would be known to one with ordinary skill in the art given the teachings contained herein.

The present disclosure provides a formulated conductive grease for an associated bearing that can be used in a drive system, such as a variable frequency drive system for motors having a formulation sufficient to reduce the voltage build up that causes damaging electric discharge machining (“EDM”) on rotational bearing supported surfaces, such as inner and outer races, while still maintaining a grease composition suitable for bearing long life at operational temperatures. The higher conductivity of the inventive grease results in lowering of the threshold voltage of pulse discharges, which consequently decreases the energy release in each pulse and the resulting bearing temperatures, avoiding bearing damage. The disclosure further provides a bearing lifetime prediction model given typical discharge conditions from both Si and SiC inverters using a bearing state of health (SOH) metric.

The inventors have discovered that voltage build-up between surfaces in the bearing, particularly the balls or rollers and outer and inner races, causes harmful discharge energy that pits the surfaces in a form of EDM. Test results show that conventional conductive greases are unable to lower the bearing discharge energy below a threshold value to avoid the EDM. Modeling predicts that a threshold value as an example can be 34 nanojoules (nJ) with minor damage almost unnoticeable to the eye and 17 nj with no damage detected even with a microscope and has been supported by test data.

The inventive conductive grease includes graphene nanoplatelets. The formulations described herein can lower the discharge energy to about 28 nJ below the first threshold value of 34 nJ in some examples and in other examples lower to about 8 nJ, significantly below even the lower threshold of 17 nJ. Experiments show that the lowered energy level using the formulated conductive grease does not cause harmful pitting from EDM, therefore extending the life of the bearing. Standard bearings materials suitable for the load when used with the disclosed conductive grease can have a significant extended life that otherwise would prematurely fail with the EDM pitting of the bearing surfaces. Motors and other machinery, and systems having such motors and other machinery, using the bearings with the disclosed conductive grease can remain operational longer compared to bearings without the disclosed conductive grease formulations.

The inventors developed a model and test equipment to determine the cause of bearing premature failures, yielding threshold values to determine effectiveness of conductive greases. Then, the inventors developed conductive grease formulations that resulted in lowered discharge energy below the threshold that surpassed commercially available conductive greases.

### Threshold for Conductive Grease Effectiveness

Sometimes an invention is discovering a root cause of a problem to develop a solution to the problem. In this case, the inventors earlier developed a system and test equipment needed to test multiple criteria and discovered the root cause. The discovery was that the root cause was EDM pitting, as referenced above. However, the extent of the damage and a threshold level was unknown.

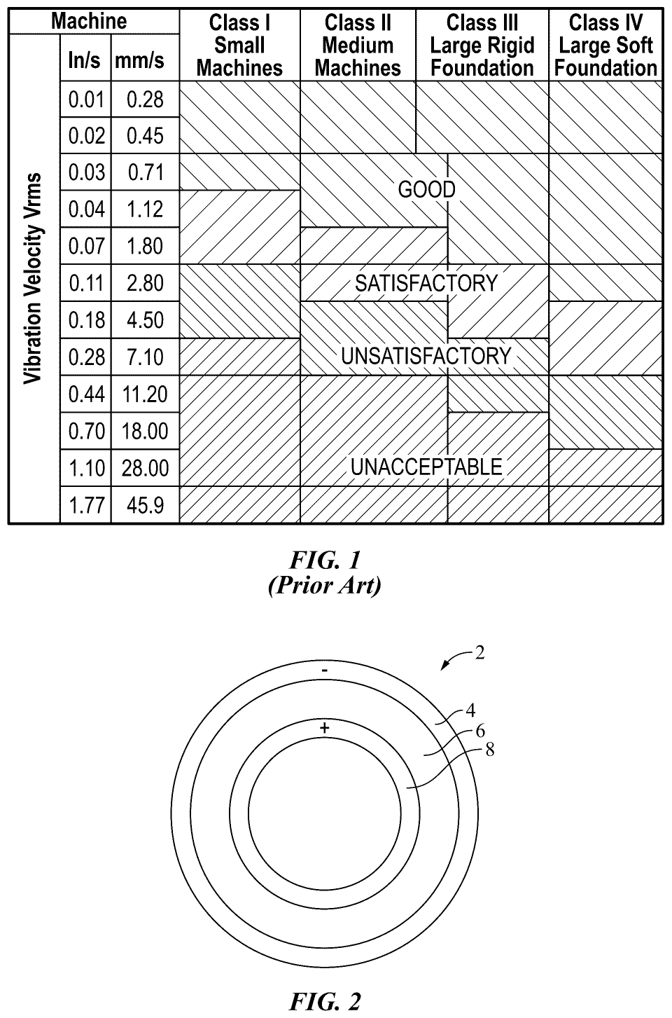

FIG. 1 is a known chart of ISO 10816-1 standard that contains general guidelines for machine vibration measurements used as a metric in the analysis described in the disclosure of the invention. The inventors developed a testing system and process at ultra high-speed to monitor machine vibrations and measure amplitude and frequency of the vibrations generated by damage spots, which is generally described by ISO 10816 and ISO 13373, and acoustic emission analysis, which is attuned to high-frequency signals from the presence of imperfections as described in ISO 22096. A machine vibration measurement that would indicate a bearing failure, e.g., a fatigue pit on the raceway of the bearing, can then be determined for different classes of machines, as shown in FIG. 1. While an absolute standard for a heavily damaged bearing due to electropitting does not exist, the thresholds developed by the inventors can indicate that preventive maintenance is required.

FIG. 2 is an illustrative diagram of a bearing containing a grease as described in the disclosure. The bearing 2 is generally a bearing having point or line contact between members such that intense heat through an electric discharge is transferred through a minimal surface area. Generally, a bearing having balls as spherical surfaces for theoretical point contact and bearings having rollers having cylindrical surfaces for theoretical line contact are representative. The bearing 2 generally comprises an outer race 4 and an inner race 8 with the bearing elements 6 between the races, often with seals between the races to retain grease between the races for the bearing elements. Generally, one race is fixed and the other race rotates relative to the fixed race using the bearing elements to support the rotational movement.

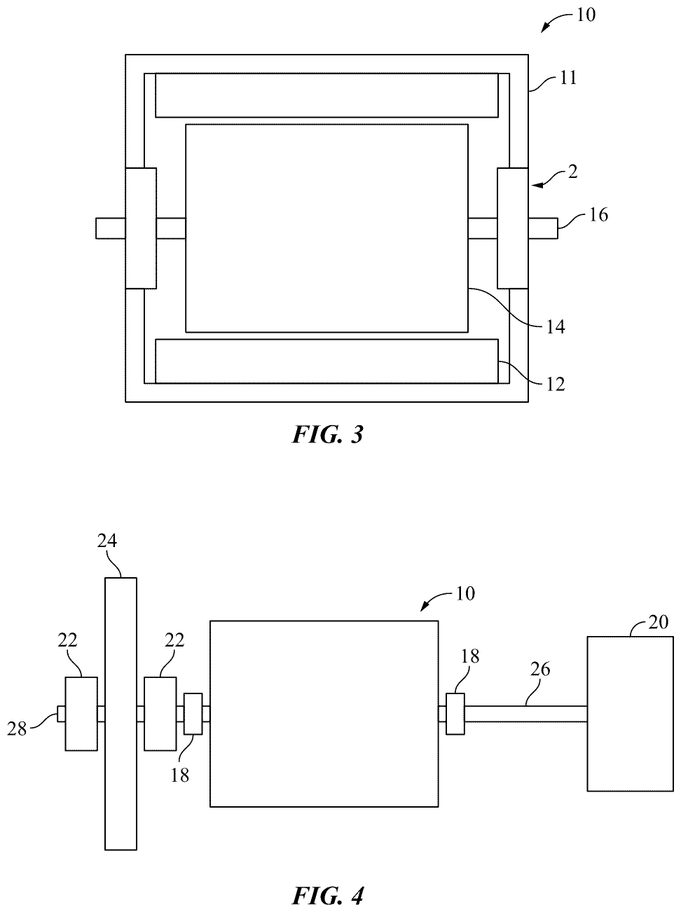

FIG. 3 is an illustrative diagram of a motor or generator with a bearing of FIG. 2. The motor as a driver or generator as a driven (herein collectively “motor” for convenience of reference) includes one or more of the bearings 2. The motor 11 generally has a housing 11 also known as a frame) to support the components of the motor. A customary construction is a stator 12 with winding electrically coupled to an external power source is fixedly attached to a periphery of the motor housing. A rotor 14 with a shaft 16 passing longitudinally through the rotor on a central axis is rotationally decoupled from the stator and rotates within an inner volume of the stator with a small annulus between the rotor and the stator. A magnetic field between the rotor and stator causes the rotor to rotate and thus produce rotational power from the motor. The rotor is held in radial alignment within the stator by two bearings 2 generally at opposing ends of the motor housing 11. The shaft 16 can extend in one or both directions beyond the motor housing to allow a coupling to attach to another shaft to be driven by the motor output power. If the motor functions as a generator, the motor is driven by an external rotational power source so that a magnetic field is generated and produces electrical energy from the motor generally to be used to power other devices. In other embodiments (not shown), the rotor and stator position can be reversed so that the stator is within a volume of a radially surrounding rotor.

FIG. 4 is an illustrative diagram of a system having a motor or generator of FIG. 3 coupled to a rotatable device and a stationary device. The system 17 can include the motor 10 that can provide power to one or more devices, where at least some of which can use one or more of the bearings 2. In the example, the motor 10 can be coupled with a coupling 18 to a shaft 26 that is a component of another device 20 that may be fixed in position with internal components that rotate such as a pump, generator, or other device. If the motor 10 is provided with a shaft extending through the opposite end, another coupling 18 can be used to connect to another shaft 28 upon which a rotational device 24 is mounted. The shaft 28 and rotational device 24 can be supported by at least one and generally two bearings 2 on both sides of the rotational device.

### Parameters and Assumptions

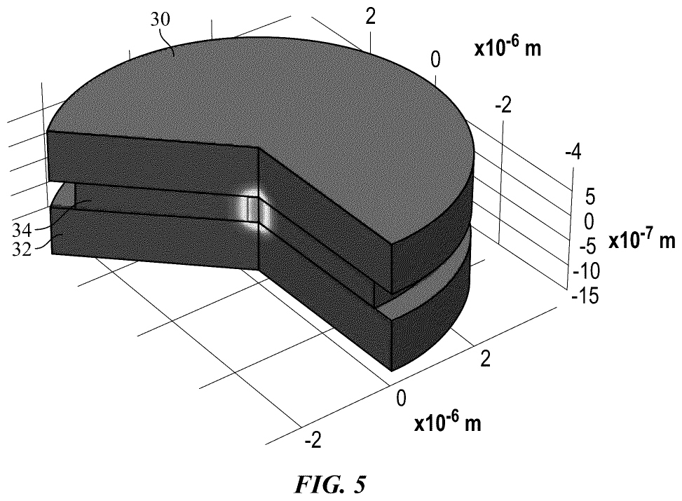

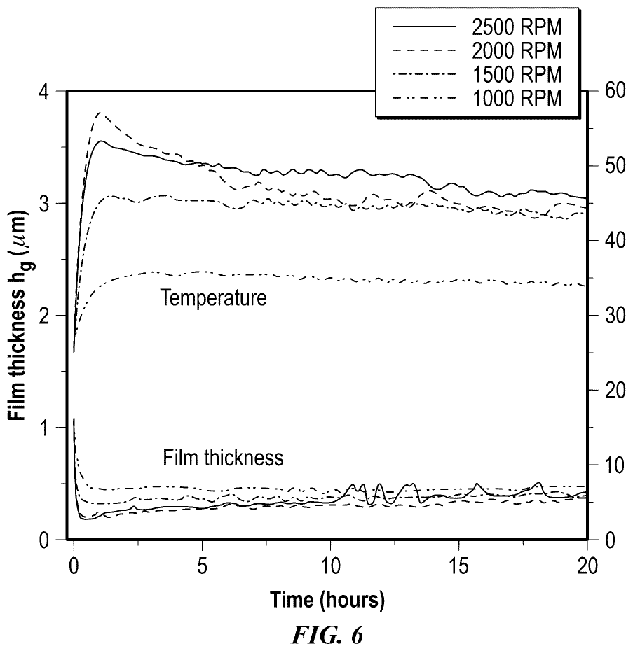

FIG. 5 is an illustrative 3D temperature model of bearing electrical discharge used in generating and analyzing results in the disclosure. FIG. 6 is an illustrative graph of experimental film thickness of bearing grease relative to time at different rotational speeds. To simulate the electric discharge between the motor bearing inner race (where the shaft voltage builds up) and the ball, and the ball and the outer race (connected to the motor frame), a simple 2D geometry of two rectangles with a gap (representing the grease) is used. The 2D model is then axially rotated to represent the 3D model, as shown in FIG. 5. At this stage, the upper layer 30 and lower layer 32 represent the ball bearing 6 and the outer race 4 from FIG. 2, respectively. The inner layer 34 represents the grease layer, with thicknesses ranging from 0.3-0.5 μm, which is the thickness range of typical greases, such as lithium carbide (LiC) polyalphaolefin (PAO) grease, in motor bearings running between 1500-2000 rpm, as shown in FIG. 6. The initial electric discharge region is superimposed on the grease layer and is approximated by a rectangle with a width of 0.4 μm. These simple rectangular geometries can be used, because, at such a small scale in comparison to the size of the ball and race, a curved surface is essentially flat at the micron scale. The overall scale of the modeled volume is suggested by a comparison of the thermal diffusivity of the materials involved and the time scale of the energy dissipation event in the electrical discharge.

To simulate the heat being produced by the discharge, the modeled voltage and current using PSpice, a circuit simulation and verification solution software, is directly input into the model, with the energy calculated using Eq. (1).

To simulate the heat being produced by the discharge, the modeled voltage and current using PSpice is directly input into the model, with the energy calculated using Eq. (1).

E=∫₀^{t}V(t)I(t)dt (1)

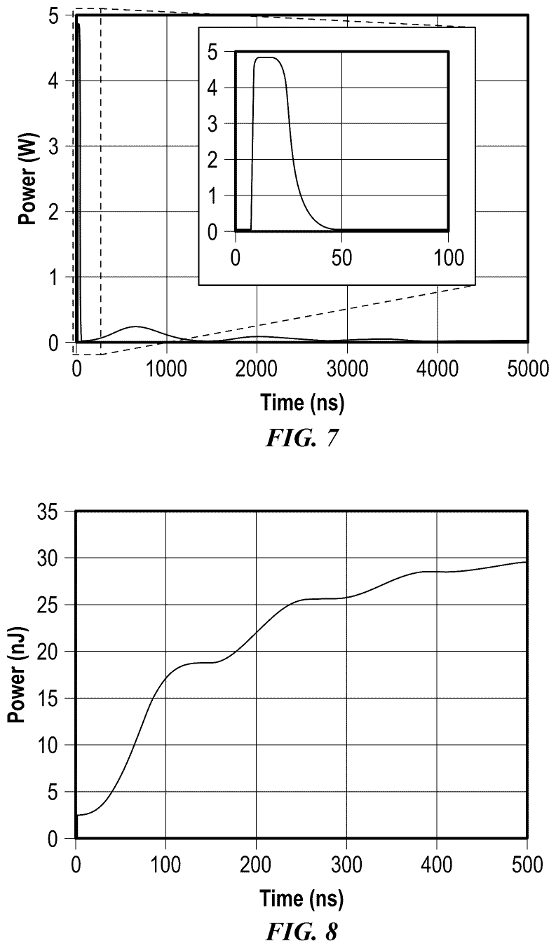

FIG. 7 is an illustrative graph of an input energy graph for a 5V discharge modeled in PSpice with an inset plot that shows a 0-100 ns region magnified to emphasize an initial electric discharge. FIG. 8 is a simulated energy graph based on a 5V discharge in PSpice. This energy is evenly distributed through the discharge region and is simulated to be converted to heat as an electric discharge through the grease, with the heat then transferred to the steel. This is implemented in the model using the heat transfer for fluids and solids physics, which allows the grease/steel interface to function properly. FIG. 7 shows the shape of the electric power flow through the system for a 5V shaft voltage discharge on a modified motor, as determined using the PSpice model developed, with the inset plot showing the 0-100 ns region magnified to emphasize the initial electric discharge. The authors have found that the follow-on waves are caused by the self-inductance of the grounding wire between the isolated bearing outer race and the motor frame used to measure the bearing current. This causes a damping effect on the electrical discharge, which leads to a slower rate of energy dissipation in the discharge column. Since the grounding wire alters the discharge phenomenon, an accurate FEM describing a modified motor is of vital importance in determining the electric discharge machining (EDM) damage that results from discharges in an unmodified motor. FIG. 8 shows the resulting cumulative energy dissipated curve in PSpice. To estimate damaging discharge voltages, the discharge voltage parameter is swept between values known to cause damage and values known to not cause damage in experimental work.

Based on the experimental research, the electric discharge parameters of voltage and current magnitude vary proportionally, as discussed below. Therefore, the simulated runs are labeled solely based on the maximum voltage of the discharge.

An ambient temperature of 40° C. is used for the model initial conditions, with the boundaries fixed to ambient. Again, to ensure that the transition from the fluid grease to the solid steel is calculated properly, the heat transfer for fluids and solids physics is used.

Pyrolysis of the grease is simulated as an irreversible phase change in the grease: once the grease reaches 300° C. [36], the fluid consumes 1.7 MJ/kg of energy to produce carbon black.

### Methods of Acquiring and Analyzing Model Data

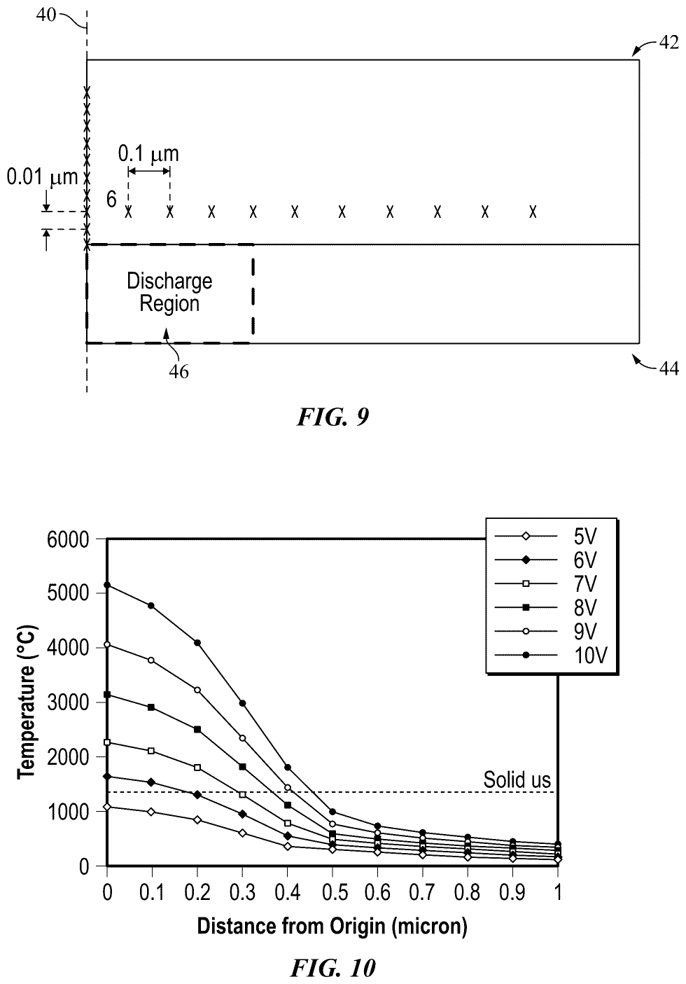

FIG. 9 is an illustrative diagram showing the location of a heat indicator probes about a central axis of rotation with a spacing of 0.1 μm. To monitor the calculated temperature of the bearing in the finite element method (“FEM”), temperature probes are placed at 20 locations on the bearing as shown in FIG. 9: one at the center axis 40 (on the left edge of the schematic, and 0.02 μm inside the steel domain 42 (i.e., above the grease/ball interface), ten in the parallel direction of the grease/ball interface 44 at a spacing of 0.1 μm to measure the breadth of the discharge region 46, and nine along the center axis with a spacing of 0.01 μm to measure the depth. These probes were placed to determine the volume that exceeds the solidus temperature of the steel.

FIG. 10 is an illustrative graph of calculated maximum temperatures at a depth of 0.02 μm into the steel for 5-10V with a discharge radius of 0.4 μm and a grease thickness of 0.35 μm. The maximum temperature at each probe location in the transversal direction (i.e., the direction along the Steel-Grease interface) for various voltage discharges is shown in FIG. 7 for several shaft discharge voltages.

A threshold for damage of a calculated temperature above the solidus temperature of the steel (the temperature at which a liquid phase can be expected to start forming in the steel) at a location of 0.02 micron into the steel is applied. The rationale is that a liquified spot smaller than that will not lead to perceptible damage. This criterion may be revised in the future, depending on further analysis of the damaged steel surface using more advanced scanning electron microscope (SEM) imaging.

In FIG. 10, the red line labeled 6V gives a maximum temperature just above the solidus temperature of the steel at the center of the model (0 μm from the center), whereas the darker blue line labeled 5V is just below the solidus temperature. Linearly interpolating between these two values to determine the shaft electric discharge voltage that results in bearing damage yields a calculated value of 5.6V, which lies between the lowest voltage tested experimentally that showed damage (6V) and the highest voltage that did not show damage (5.5V).

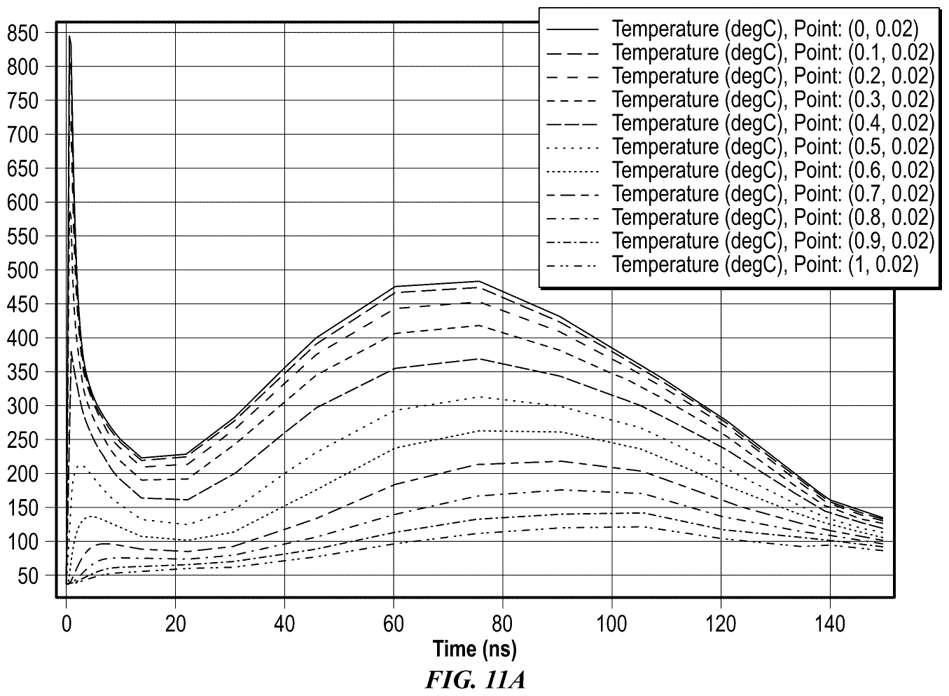

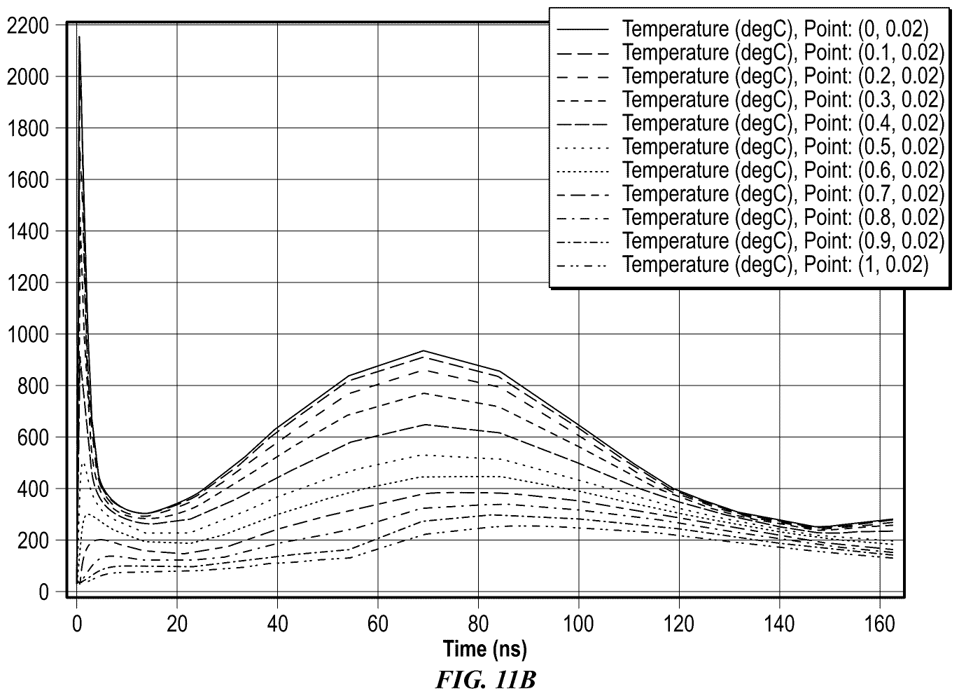

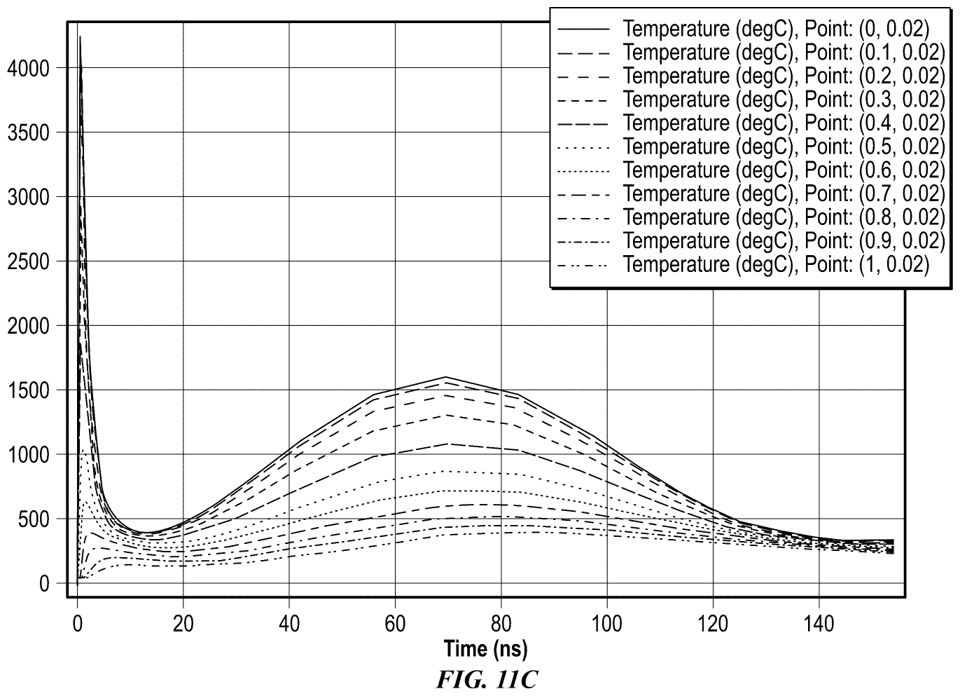

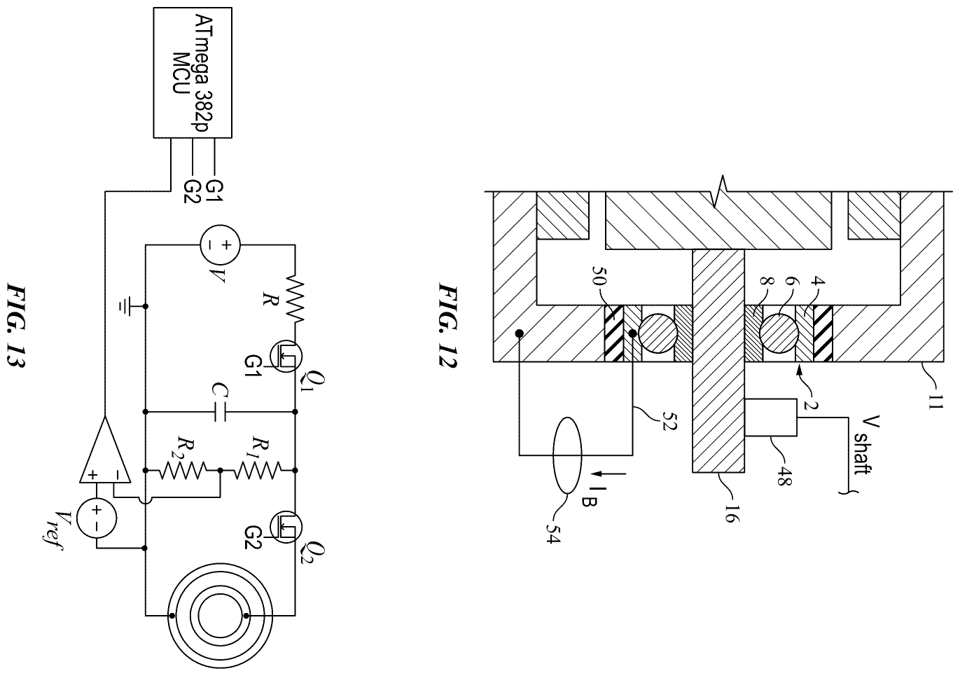

FIG. 11A is an illustrative temperature profile of a steel/grease interface during the first 0.15 us of 5V runs with a discharge radii of 0.4 μm and a grease thickness of 0.35 μm. FIG. 11B is an illustrative temperature profile of a steel/grease interface during the first 0.15 us of 7.5V runs with a discharge radii of 0.4 μm and a grease thickness of 0.35 μm. FIG. 11C is an illustrative temperature profile of a steel/grease interface during the first 0.15 us of 10V runs with a discharge radii of 0.4 μm and a grease thickness of 0.35 μm. Confirming that the model results match experimental observations, the inventors examined other implied features of the discharge events. The inventors discovered that the steel experiences large temperature changes in the first nanosecond in the 0.02 μm depth to a radius of ˜0.4 μm, creating damage even in the initial spike in energy.

### Experimental Validation

For the necessary experimental validation and for comparisons with the FEM above, a motor-generator dynameter testbed was designed and implemented to vary the load, temperature, and speed of an induction motor (“IM”) and a permanent magnet (“PM”) motor. In the testbed, a 7 kW, 460V Si IGBT VFD was employed, as well as a 250 kW, 460V SiC inverter, using 900V/2.5 mΩ SiC high performance, half-bridge MOSFET power modules. As a non-commercially available evaluation unit, the SiC inverter has no system level controller. For flexibility and rapid prototyping/testbed development, the inventors utilized a Typhoon hardware-in-the-loop (HIL) 402 system, which is also used to operate as the system level controller for the SiC inverter.

FIG. 12 is an illustrative diagram of a motor modification for bearing current measurement. To measure shaft voltage, a shaft voltage brush was fixed to the motor. To measure bearing currents, the motor under test was modified with an insulating sleeve, such as made of polyoxymethylene, between bearing outer race and machine frame to isolate the bearing. A jumper wire was connected from the outer bearing race to machine frame, forcing the bearing current through the wire for measurement.

Since the bearing discharge voltage (and therefore the discharge energy) is dependent on the loading, temperature, and speed of the motor, each parameter needs to be controlled and varied using the motor-generator dynamometer testbeds. Thus, the motor-gen dyno testbed is controlled to vary load, speed, and temperature (can be controlled externally by heating pads). From the motor-gen dyno testbed, it is shown that the shaft voltages and bearing currents from the Si- and SiC-based inverters follow statistical distributions that are dependent on speed, bearing temperature, and loading.

As mentioned previously, since the energy released in a bearing current discharge was previously stored as electrostatic shaft voltage buildup, the magnitude of the bearing current discharge is linearly proportional to the shaft voltage at the time of breakdown. Therefore, a given bearing current peak amplitude relates to a particular shaft voltage. For the motor-inverter testbed, the experimentally determined linear relationship between the shaft voltage and the peak bearing current is described by:

i(v)=0.05v−0.08,i>0 (2)

This was obtained using experimental shaft voltage and bearing current, and the MATLAB curve fitting toolbox, resulting in this best line of fit. To experimentally verify the FEM results, a set of experiments were carried out to understand the effect of the influence of the varying nature of the shaft voltage and bearing current discharges on the damage that occurs on the surface of the ball and races of the bearing. Several discharge intensities were chosen along the linear relationship of Eq. (2).

FIG. 13 is an illustrative diagram showing bearing testbed circuitry to control the amplitude of discharge that a bearing experiences. To control the amplitude of the discharge that the bearing is experiencing, the illustrated switching circuit was developed with MOSFETs and a microcontroller unit (MCU).

A testbed corresponding to the circuit included a VFD along with a ¼ hp induction motor (IM) to spin up a 5 hp rotor. The radial and axial forces acting on a bearing affect the discharge activity [39], therefore the same rotor used on the 5 hp machines for this research is employed in the testbed. To prevent the shaft voltages of the IM from distorting the experiments, an insulated shaft coupling is used between the IM and the rotor. The system in FIG. 13 operates as follows: first the MCU turns on switch Q1 to charge the capacitor C. Then, once the voltage across the capacitor is equal to the supply voltage V, switch Q1 is turned off and switch Q2 is turned on, which allows the electrostatic energy stored in the capacitor to be discharged through the bearing. The resistive divider comprising R1 and R2 is used to sense when a discharge occurs by comparing the voltage of the divider with a reference voltage Vref that is less than the supply voltage V. When the voltage of the divider is less than the voltage of the reference, the output of the op amp comparator is driven high, which notifies the MCU that a discharge has occurred. A discharge counter is then incremented within the MCU, and the process repeats.

Large values were selected for R1 and R2 in FIG. 13, such that the time constant (R1+R2)C is much larger than the time it takes for a discharge to occur after Q2 is closed. This ensures that the discharge counter is incremented only when a discharge occurs within the bearing.

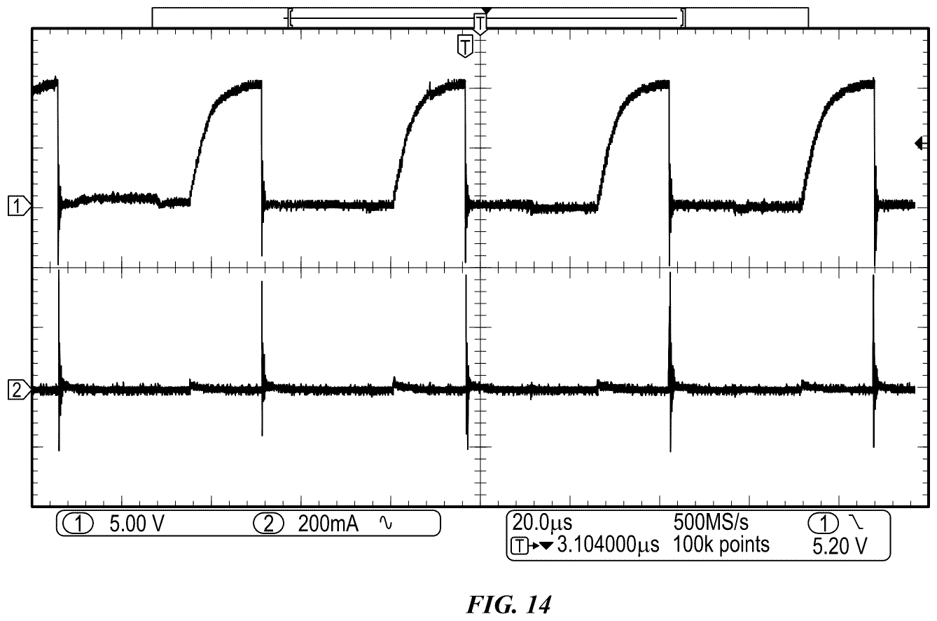

FIG. 14 is a graph of experimental shaft voltage and bearing current discharge measurements on the bearing testbed for a total of 10V, 400 mA test for two divisions with 5V, 200 ma per division. The shaft voltage is the top line (line 1) and the bearing current is the bottom line (line 2). An oscilloscope capture of the discharges applied to the bearing is shown in FIG. 14 for a 10V, 400 mA test. The discharge shape emulates discharges that are seen from experimental measurements on inverter-driven machines], with the key difference that the circuitry allows for discharge amplitude control.

A summary of the experiments performed along with the damage result is shown in Table 1. Note that the shaft voltage and bearing current experimental conditions of column 1 follow the relationship of Eq. (2). To select the discharge amplitudes of Table 1, the FEM was used in tandem with an experimental bisection method and engineering intuition. After completing a few of the experiments, it became clear that damage could be detected on the ball and race surfaces of the bearings with fewer discharges. This explains why each discharge amplitude test doesn't have an equal number of discharges.

TABLE 1

| Experiment | Energy/Discharge | | # of Discharges | Damage |
|---|---|---|---|---|
| 17 V, 700 mA | 316 | nJ | 12,983,774,249 | ****** |
| 16 V, 650 mA | 280 | nJ | 11,057,372,599 | ****** |
| 10 V, 400 mA | 110 | nJ | 5,394,301,756 | **** |
| 7.5 V, 300 mA | 62 | nJ | 7,396,457,952 | **** |
| 6 V, 240 mA | 40 | nJ | 10,511,137,690 | *** |
| 5.5 V, 220 mA | 34 | nJ | 6,124,563,786 | ** |
| 5 V, 180 mA | 27 | nJ | 4,268,783,089 | ** |
| 4 V, 125 mA | 17 | nJ | 7,970,709,414, | * |

***** Significant frosting on race surface, pits and pillars visible
**** Frosting on the race surface, pits and pillars visible
*** Slight frosting on the race surface, pits and pillars visible
** Very light frosting on race surface, difficult to detect with human eye
* No frosting or EDM damage detected, even with microscope

After each experiment, the bearing was cut open and examined with an SEM to evaluate the damage due to the discharges applied.

From Table 1 and the SEM examination of the cut open bearings, the experimental threshold for an EDM discharge to create damage to the steel of the race and balls is between 5.6-6V, in alignment with the FEM, which corresponds to energies between 34-40 nJ. Below 34 nJ, the energy of the discharge results in slight pyrolosis of the grease, but may not cause EDM damage to the steel of the balls or races. Therefore, the accuracy of the FEM is validated experimentally, and can be used to make predictions about the damage that is occurring inside of the bearing for scenarios that are difficult to be evaluated experimentally, including accurately determining the bearing current in a motor that has not been modified with grounding wires between isolated bearings to the motor frame to enable the measurement of the bearing current. The validated FEM can also be used for damage assessment for the development of an inverter duty bearing.

Development of Conductive Grease for Bearings with a Discharge Energy Below Thresholds

In the presented FEM and experimental validation, the authors determined that decreasing the energy in the bearing current discharges can prevent damage. This can be accomplished by employing conductive bearings of even standard bearings modified by employing conductive bearing grease. The expectation is that the higher conductivity of the grease results in lowering of the threshold voltage of pulse discharges, which consequently decreases the energy release in each pulse. The inventors' research focused on the use of greases whose formulation already yields volume resistivities in the range of 20-650 Ω*cm (conventional bearing grease has resistivities of ˜1.0×10⁸ Ω*cm) with kinematic viscosity close to that specified by the bearing manufacturer—usually in the range of 30-125 mm²/s at 40° C. The kinematic viscosity requirements are helpful in differentiating from electrically conductive greases that are unsuitable for supporting bearing operation that would itself cause premature failure of the bearing.

Using a locally developed method to “unpack and repack” bearings that includes a thorough cleaning and re-greasing process, the re-packed bearings were tested on motors using both Si and SiC inverters. The goal was to characterize the measurable shaft voltages, bearing currents, and observed damage when conventional and conducting greases were employed in the bearings.

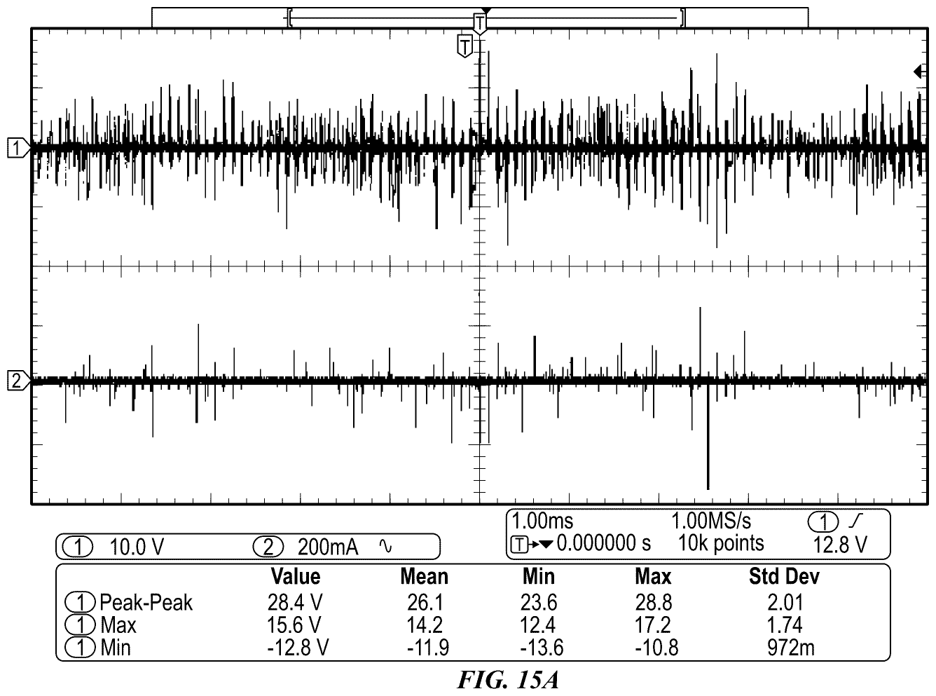

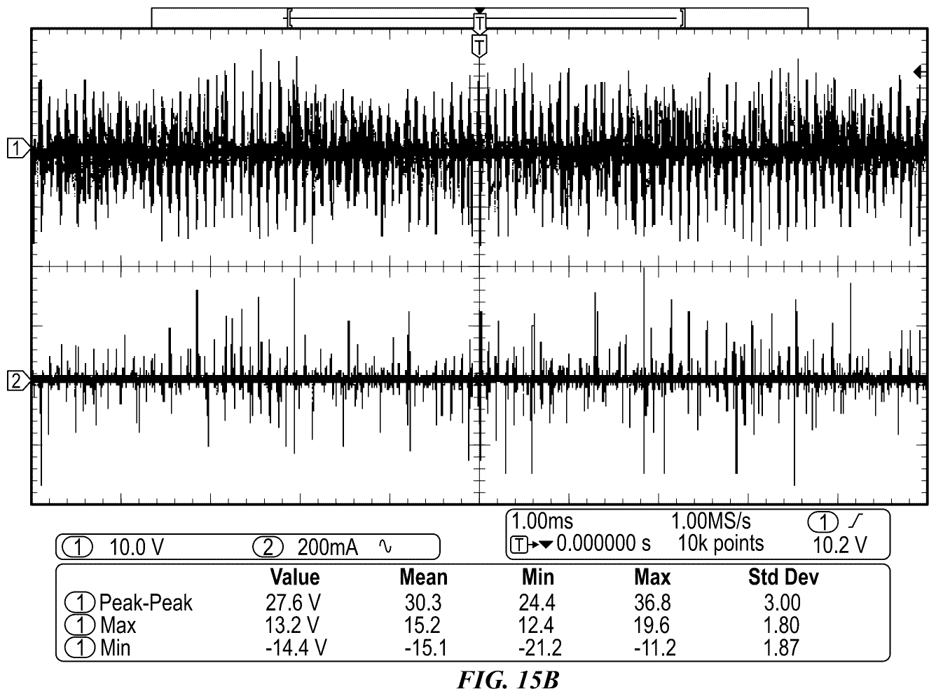

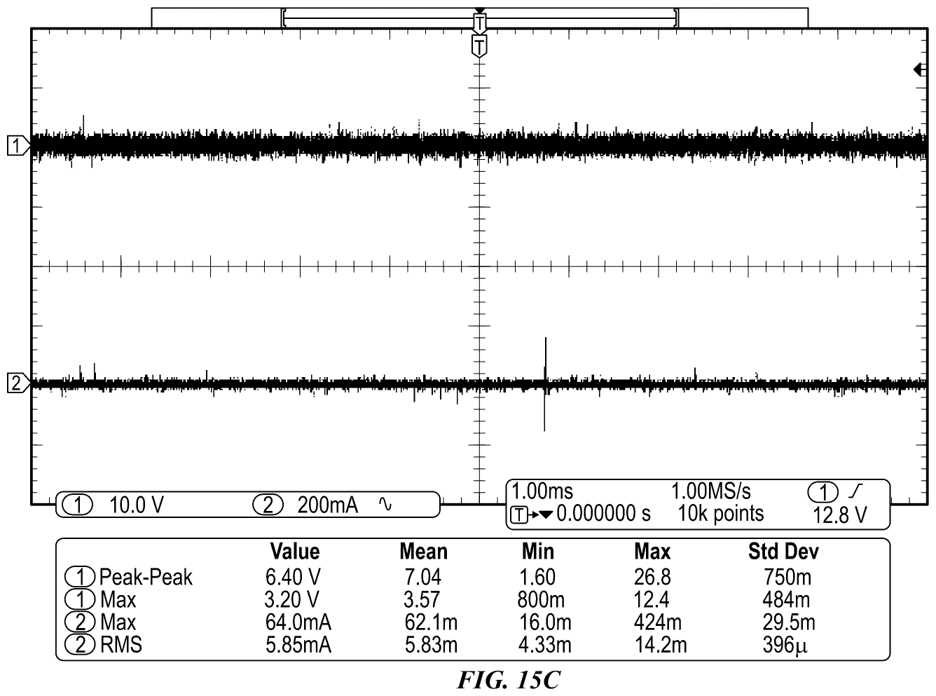

FIGS. 15A-15C show oscilloscope captures of shaft voltages (blue) and bearing current (red) for three individual experiments, all with identical magnitude (vertical) and time (horizontal) scales. FIG. 15A is a graph of experimental Si shaft voltage (top—line 1)) and bearing current (bottom—line 2) max peak to peak (“p-p”) 28.8V at 270 mA. FIG. 15B is a graph of experimental SiC shaft voltage (top) and bearing current (bottom) max p-p 36.8V at 400 mA. FIG. 15C is a graph of experimental Si shaft voltage (top) and bearing current (bottom) with conducting grease.

Comparing the blue trace of FIGS. 15A and 15B, it is evident that the higher dv/dt induced by SiC devices causes increased shaft voltages. Likewise, comparing the red traces in FIGS. 15A and 15B indicates that the bearing currents are exacerbated in SiC-based systems. Examining the voltage and current traces in FIG. 15C, it is evident that the shaft voltage and bearing current are decreased when a conducting grease is used, mitigating the damage problem when a Si-based inverter is used.

Although the conducting grease proved to significantly lower the shaft voltage and bearing current for Si-based systems, due to the higher dv/dt in SiC-based systems, the conducting grease was unable to lower the discharge energy for the SiC-based systems to a level below the damage threshold of advantageously between 17 nJ and 34 nJ, depending on the amount of acceptable service life desired and predicted by the FEM and confirmed through the experimental validation. To further improve the performance of the conductive grease, graphene nanoplatelets were integrated into the conductive grease.

The graphene nanoparticles can have a surface area of 2-2000 square meters per gram (m²/g). In at least one embodiment, the graphene nanoplatelets have a surface area of 500 m²/g and are commercially available. Based on a particular composition and other factors, a different density could be used as can be determined through experimentation; the weight percentage can vary. The conductivity of these graphene composites is explained on the basis of “percolation theory”: as long as there are sufficient numbers of flakes that they can provide a more-or-less continuous conduction chain, then conductivity can be acceptably good, but if the amount falls just below that threshold, the conductivity becomes almost immediately unacceptable. Depending on the composition and grease, a range of 0.1 wt % to 20 wt % could be used. Based on experimental data, an advantageous range could be 5 wt % to 15 wt %.

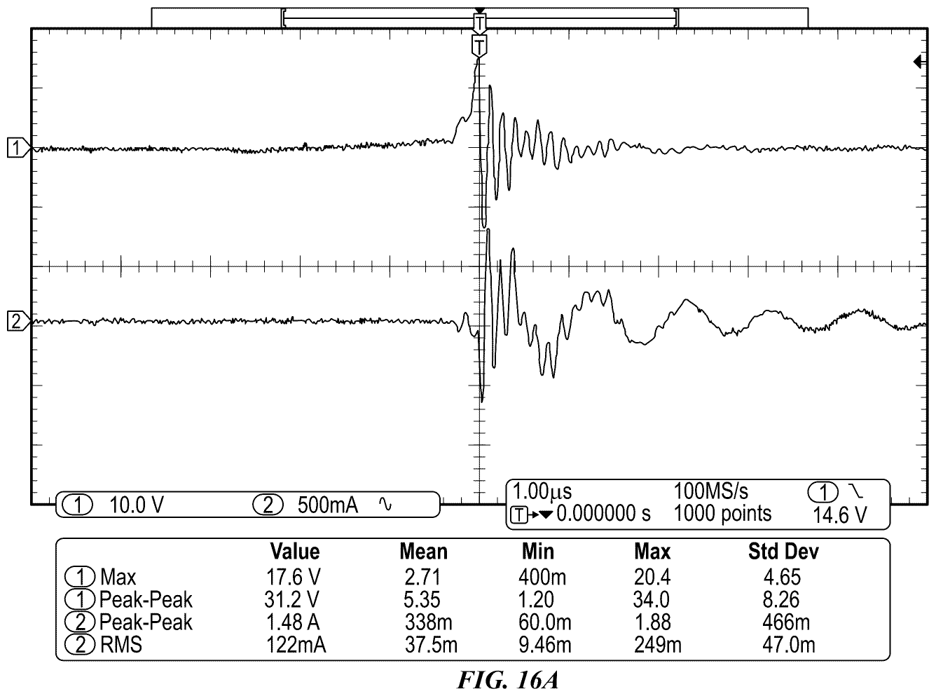

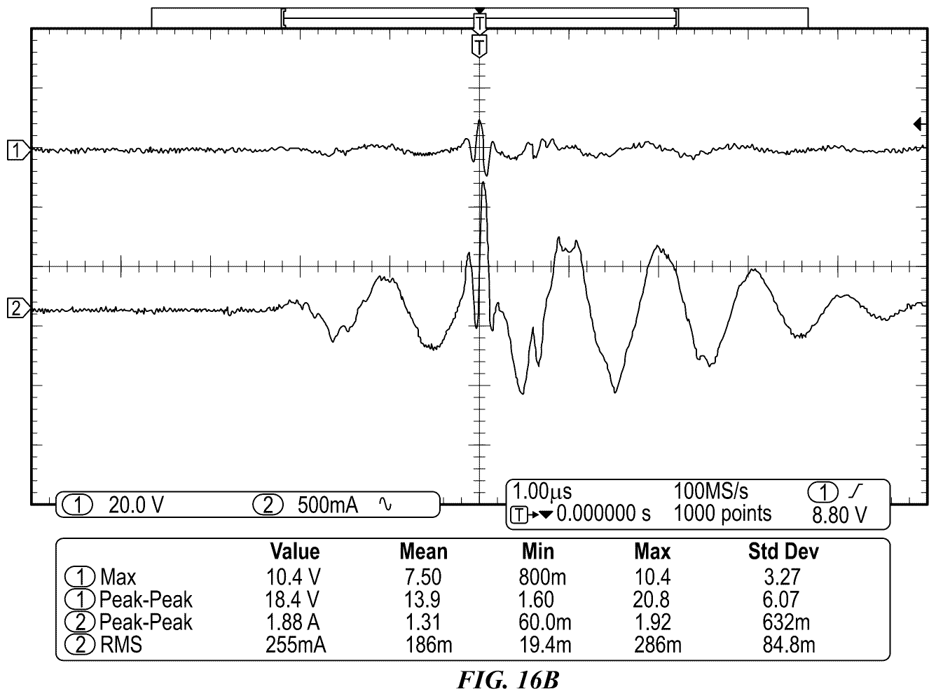

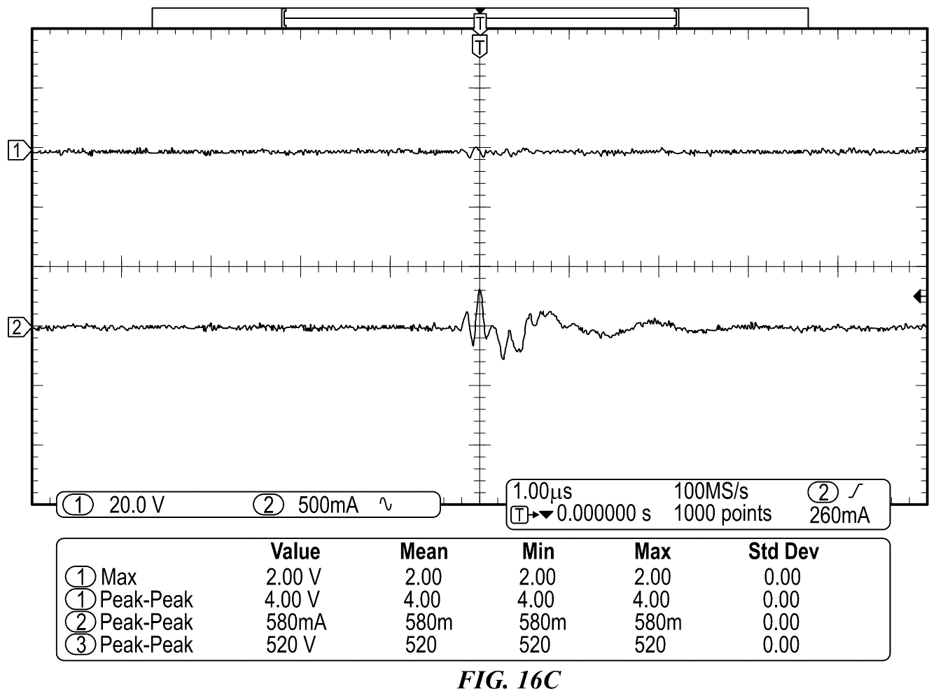

FIGS. 16A-16C show the shaft voltage and bearing discharge current of the motor in the testbed driven by a SiC-based inverter. FIG. 16A is a graph of experimental shaft voltage (top—line 1) and bearing current (bottom—line 2) for a fully loaded 460V 5 hp motor driven by a SiC-based inverter for normal grease. FIG. 16B is a graph of experimental shaft voltage (top) and bearing current (bottom) for a fully loaded 460V 5 hp motor driven by a SiC-based inverter for conducting grease. FIG. 16C is a graph of experimental shaft voltage (top) and bearing current (bottom) for a fully loaded 460V 5 hp motor driven by a SiC-based inverter for conducting grease modified with graphene nanoplatelets.

A significant decrease in the shaft voltage and bearing current is evident between FIGS. 16B and 16C, where the discharge energy in FIG. 16C (˜28 nJ) is lower than the damage threshold of 34 nJ. This conducting grease/graphene mixture was further tested on an unmodified motor driven by the SiC inverter for one week to determine if the bearing would exhibit any EDM damage. After the week, both the load-end and drive-end bearings were cut open for inspection. It was found that neither the load-end nor the drive-end bearing had any damage.

Formulations for Conductive Grease with Graphenes

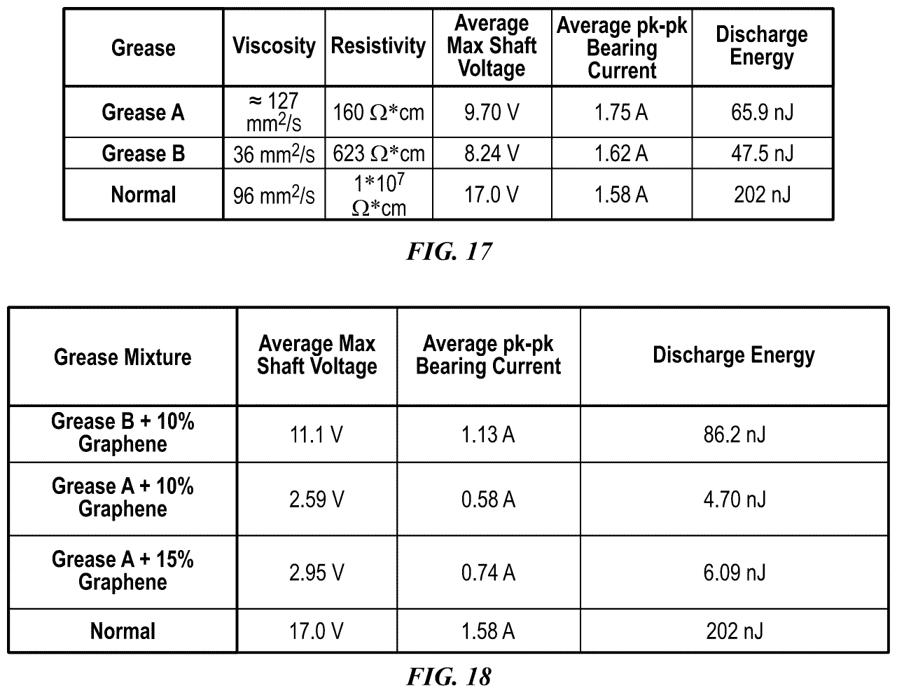

FIG. 17 includes the commercially available conductive greases and results of testing as to whether they meet the threshold levels that are needed to avoid the EDM damage. Having discovered the cause of the damage to the bearings through EDM shaft discharge energy, especially from SiC-based systems, and the threshold to avoid such damage, the inventors conducted experiments on commercially available conductive bearing greases.

The conductive lubricants selected for testing were chosen based on their electrical and rheological properties. Specifically, the greases chosen were selected due to their kinematic viscosity and operating temperatures being close to that of the conventional grease specified by the bearing manufacturer, which was found to typically be in the range of 30-125 mm²/s at 40° C. Choosing similar viscosities was important in order to minimize the variables introduced to the system and to specifically observe the effects of an increase in lubricant conductivity without significantly altering the film thickness. The greases chosen for test were those whose formulation yielded volume resistivities in the range of 20-650 Ω*cm. (Conventional bearing grease has a volume resistivity of ˜1.0×108 Ω*cm.) The conductive grease bearings were tested on motors driven by both the Si- and SiC-based inverters with the goal to characterize the measurable shaft voltages, bearing currents, and observed damage when conventional and conductive lubricants were employed. The experimental oscilloscope captures seen in FIG. 13 capture the shaft voltages (blue) and bearing currents (red) for three separate experiments with identical magnitude (vertical) and time (horizontal) scales. The grease manufacturers are anonymously marked for the sake of the manufacturers. The lowest discharge energy was Grease C with 47.5 nJ, above the needed threshold of 34 nJ that results in barely perceptive damage viewed by the human eye threshold and far above the needed threshold of 17 nJ that results in no damage seen, even under a microscope.

FIG. 18 includes modified commercially available conductive greases according to the teachings herein and their response to meeting the threshold levels that are needed to avoid the damage. Integrating graphene nanoplatelets increased the conductivity of commercially available conductive lubricants to effectively decrease the shaft voltages and bearing currents in SiC-based motor drive applications. FIG. 18 demonstrates the effectiveness of the integrated graphene nanoplatelets into commercially available conductive greases by comparing the shaft voltages and bearing current discharges of the modified motor driven by the SiC-based inverter

The difference is dramatic. Grease A went from 65.9 nJ to 4.7 nJ with 10% graphene and to 6.09 nJ with 15% graphene. (Grease B went from 47.5 nJ to 86.2 nJ with 10% graphene, perhaps do to the viscosity of this particular grease that would increase the film thickness with a thicker separation of the surfaces and a resulting higher discharge energy.)

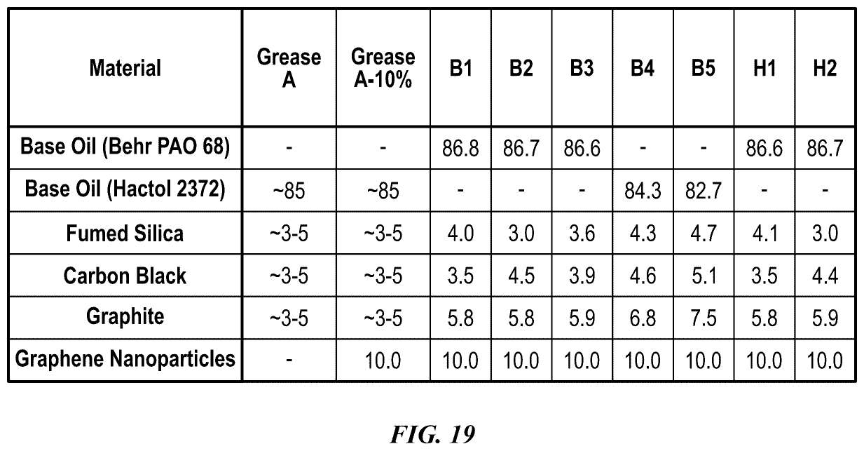

FIG. 19 is a summary chart of experimental compositions in forming low discharge energy conductive greases. With the success using the graphene nanoplatelets in commercial conductive greases, the inventors proceeded with developing custom low discharge energy conductive greases. The inventors used two known commercially available base oils: Hactol 2372, a polyolester (POE) oil, and Behr PAO 68, a polyalphaolefin (PAO) oil for a starting composition of 85-95 wt % of the grease composition. The remaining 5-15 wt % of the grease composition were conductive thickeners of carbon black, graphite, and graphene nanoplatelets, and nonconductive thickeners of fumed silica. A first composition named B1 had 10 wt % graphene as in Grease A that was modified by the inventors with 10 wt % graphene nanoplatelets (“Grease A-10%”) above.

B1 and H1 are baseline grease formations based on estimated percentages of the components in the modified Grease A-10% without knowing trade secret additives in the original Grease A formulation. B1 uses the Behr PAO 68 base oil. H1 uses the Hactol 2372 base oil. The remaining greases in the chart have compositions of the grease components as adjusted percentages relative to the B1 and H1 base formulations with a constant being 10 wt % graphene nanoplatelets. B2 and H2 replaced 25 wt % of the silica by an equal mass of carbon black. B3 replaced 10 wt % of the silica by an equal mass of carbon black. B4 increased by 20 wt % all base grease fillers. B5 increased by 35 wt % all base grease fillers.

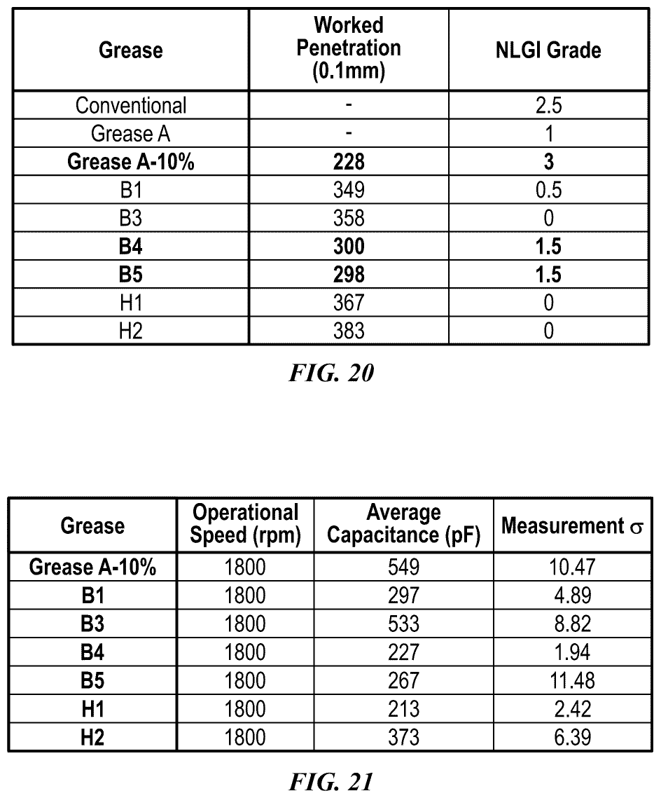

FIG. 20 is a chart of cone penetration and NLGI grades for custom and selected conductive greases. Consistency by Grades, as classified by National Lubricating Grease Institute (NLGI) is used in industry for grease consistencies and is measured by cone penetration testing. For rolling contact, the National Lubricating Grease Institute (NLGI″) Grades 1-4 are used. NLGI Grade 2 is most suitable for induction motor bearings. Experiments were made with Grades 1.5 to 3. Softer consistencies (lower NLGI grades) are associated with thinner lubricant films and higher bearing capacitances. The inventors chose Grease A-10, B4, and B5 as most suited for the application.

FIG. 21 is a chart of experimentally measured conductive grease bearing capacitances and conductivities at 1800 rpm operational speed. Bearing capacitance is experimentally measured at constant temperature. Conventional grease bearing capacitance that is measured at 1800 rpm is about 200 pF. (Some error in measurement is expected because capacitance is dependent on dynamic lubricant film thickness and EHD contact area.)

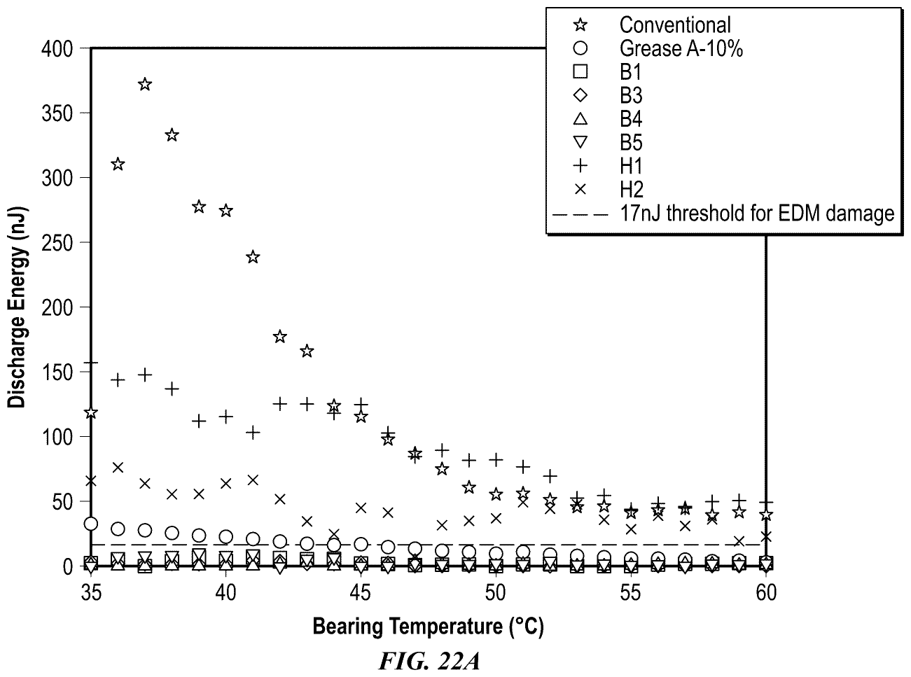

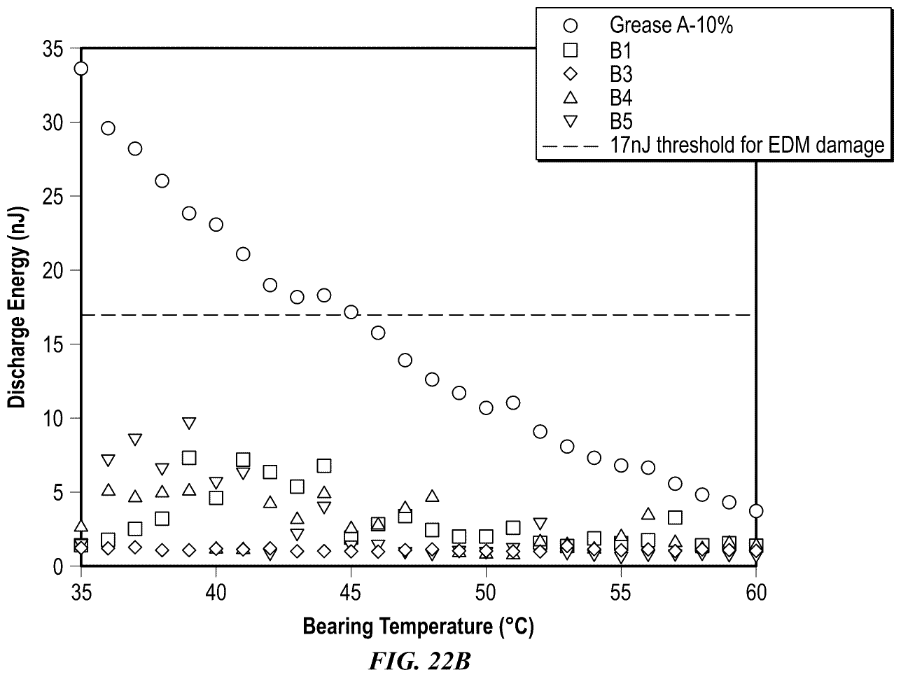

FIG. 22A is a chart of experimental discharge energies relative to bearing temperature for the tested greases in FIGS. 19-21. FIG. 22B is an enlarged scale of a lower portion of the chart of FIG. 22A. For testing, the inventors compensated for different temperatures as may occur in operation. The lubricant condition and EDM rates are temperature dependent. Heating pads were applied to motor housing to control temperature, which was monitored using a thermistor sensing circuit. The range of 30° C. to 60° C. was used to simulate ambient temperature to temperature of machine full machine loading. A time span of 1000 ms of shaft voltage and bearing current data were recorded for each ° C. Peak bearing currents and associated shaft voltages were extracted by algorithm. Maximum discharge energies for each grease at each ° C. were calculated using measured bearing capacitances. The experiment was conducted using an SiC-driven IM at 10 KHz switching frequency. All values shown are peak bearing current discharge energies for each 1000 ms data sample at each ºC.

Based on a conservative threshold of 17 nJ for no EDM damage, discharge energies associated with B1, B3, B4, and B5 produced no EDM damage for the entire temperature range. These formulations produced discharge energies that were about one half or less of the 17 nJ threshold—easily within the range of not cause damage to the damage through discharge energies.

### Lifetime Prediction of Motor Bearings Subject to EDM Degradation

An empirical relationship between the discharge energy and the size of the EDM damage spot can be developed. The energy deposited by the electric discharge is converted to sensible heat in the steel as

dₑ=m×c_{P}×(ΔT) (3)

Where m is the total mass of steel that is above the solidus temperature, c_{P} is the heat capacity of steel, and ΔT is the temperature difference between the operational bearing temperature and the solidus temperature. If mₕ is the mass of the approximately hemispheric volume Vₕ that has a time varying radius r(t), and that the heat is distributed to four steel hemispheres (inner race to ball, and ball to outer race) then,

$${V}_{h} = \frac{1}{2} \frac{4}{3} π {r}^{3} = \frac{1}{2} \frac{4}{3} π {( \frac{D}{2} )}^{3} \qquad ( 4 )$$

And therefore, a plot of Vₕ vs. dₑ should be linear.

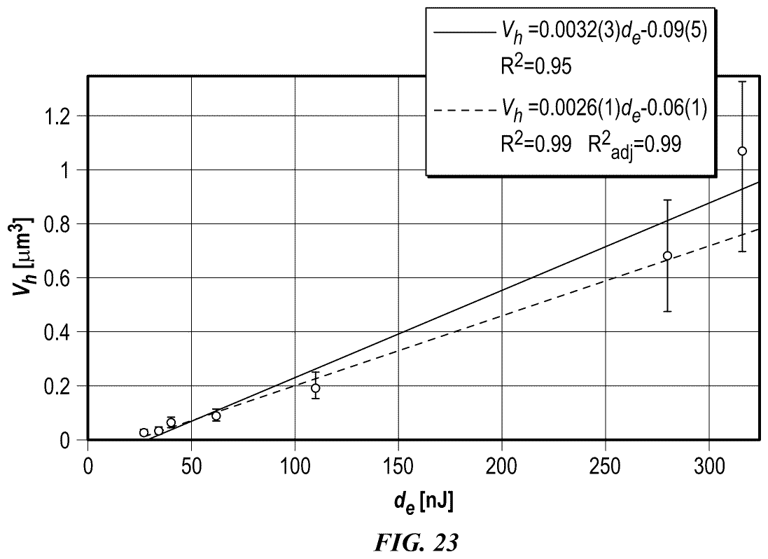

FIG. 23 is a graph of plotted data of the calculated volume of the damage hemisphere Vₕ vs. the discharge energy dₑ. The above analysis suggests that there is a lower bound for the amount of energy that causes damage, and a slope for the discharge damage above the energy threshold. This is observed in practice from the plot of Vₙ vs. dₑ shown in FIG. 23. Because the last point seems to be a high leverage point it is removed from the least squares fit in the lower line, resulting in a significantly improved adjusted coefficient of determination R_{adj}².

A least squares fit line was drawn to all data with the result shown in the blue dashed line. Because the dₑ=316 nJ point is a high influence point with high leverage, a second least squares fit line that excludes this point was fit, shown in the orange dashed line in FIG. 23, that shows a significantly improved R_{adj}² justifying the exclusion of this point. Either way, the plot in FIG. 23 seems to confirm a linear correlation between Vₕ and dₑ, and therefore, by extension, between D³ and dₑ or alternatively between D and

$${d}_{e}^{\frac{1}{3}} .$$

The resulting empirical relationship is shown below.

Vₕ=0.0026(1)dₑ−0.06(1) (5)

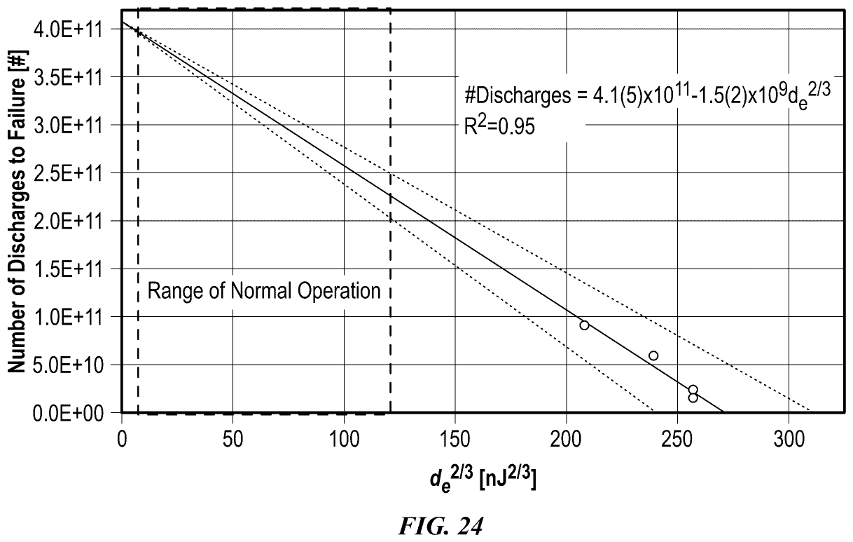

With bearing failure having such large economic impacts on motor operators, it becomes beneficial to understand how EDM degradation is related to the lifetime of a bearing. This allows operators to set proper maintenance schedules to keep their equipment operating at peak performance. An experimental procedure was developed to analyze the effect that discharge energy has on bearing lifetime using the bearing testbed presented in [10]. For timeliness, discharge amplitudes (70-90 V) were selected that are much greater in amplitude than are found on typical PWM inverter driven 5 hp induction motors, where shaft discharge voltages on 5 hp induction motors typically range from 3-35 V for Si and SiC inverters, where SiC inverters can generate slightly higher shaft voltages [8]. The higher energy discharges cause accelerated degradation of the motor bearings, allowing for practical and timely laboratory experiments. Five experiments were carried out to correlate the discharge energy with the number of discharges to failure, where failure is defined by mechanical vibration according to standard ISO 20816-1 [11]. The vibration is measured with a Fluke 805 FC vibration meter. A summary of the degradation experiments is shown in Table 2, and the results are displayed graphically in FIG. 24. The discharge rate (EDM rate) for each experiment was ˜25 KHz.

TABLE 2

| Experiment | | | # of Discharges to |
|---|---|---|---|
| No. | Experiment | Energy/Discharge | Failure |
| 1 | 90 V, 4.12 A | 8100 nJ | 16,900,000,000 |
| 2 | 80 V, 3.7 A | 6400 nJ | 59,540,000,000 |
| 3 | 70 V, 3.0 A | 4900 nJ | 90,770,000,000 |
| 4 | 90 V, 4.12 A | 8100 nJ | 15,740,000,000 |
| 5 | 90 V, 4.12 A | 8100 nJ | 24,060,000,000 |

FIG. 24 is a graph of plotted data of the observed number of discharges to failure vs. dₑ^{2/3}. Continuing the earlier analysis based on discharge energy from the previous section, if bearing failure correlates to an accumulation of damage spots that covers the entirety of the races, and since the area of the damage spot is a function of the square of the damage spot diameter, a linear dependence between number of discharges to failure and the square of the damage spot diameter should exist. Further, in the previous section it was determined that a linear correlation between discharge diameter and the cube root of the discharge energy exists. Therefore, the inventors provide a linear correlation between the number of discharges to failure and the square of the cube root of the discharge energy. This relationship is examined in FIG. 24, with the five data points collected shown and a least squares line shown, with the equation given in the figure (numbers in parentheses are the calculated standard uncertainties for the slope and intercept). The least squares line is extrapolated to the y-intercept, and the region of discharge energies expected during normal motor operation is shown in the light blue box. To help assess the uncertainty of the estimated lifetime of the bearings, upper and lower uncertainty ranges at the 95% confidence interval are also shown in FIG. 24 as the upper and lower black dashed lines.

From this analysis, a bearing that experiences only discharges at the 17 nJ level (discharge energy level at which no frosting or EDM damage was detected, even with microscope) can be expected to have a mean lifetime of 400 billion discharges. For perspective, a motor operated by a drive at 10 kHz, that experiences a 17 nJ discharge once every five switch operations can be expected to have an operational lifetime of 6.34 years.

Likewise, a motor that regularly experiences 1,340 nJ discharges (the highest value the inventors observed) can be expected to have a mean lifetime of 225 billion discharges, which, under the same conditions as above would correspond to a lifetime of 3.5 years, or about half the life.

### Shaft Voltages and EDM Bearing Currents Due to Si and Sic Inverter

FIG. 24 is a graph of bearing SOH lifetime projections for the Si and SiC inverter at various motor load points of the number of discharges to failure and a motor load with a best fit curve. The line shown is intended to guide the eye. To account for the variable nature of the EDM discharges, a bearing state-of-health metric (SOH) is defined, which attaches a numerical value to the health of the bearing at any point in its lifetime, where a value of 1 indicates a new, healthy bearing and 0 is a failed bearing.

The line shown is intended to guide the eye. To achieve this, the inventors consider that, as shown in FIG. 24, if all discharges were of energy dₑ, that the lifetime of the bearing (in discharges) is decreased to y=mdₑ^{2/3}+b. Meaning that each discharge is b/y times as damaging as the minimally damaging discharge. Therefore,

$$\frac{b}{y} = \frac{b}{{md}_{e}^{2 / 3} + b} \qquad ( 6 )$$

However, each discharge has a different energy d_{e,i}. Therefore, each discharge of energy d_{e,i} consumes

$$\frac{b}{{md}_{e , i}^{2 / 3} + b}$$

lifetime, until

$${\sum }_{i} \frac{b}{{md}_{e , i}^{2 / 3} + b} = b ⇔ {\sum }_{i} \frac{1}{{md}_{e , i}^{2 / 3} + b} = 1 \qquad ( 7 )$$

Since the inventors want the SOH to start at 1 for a new bearing and fall to 0 for a near failure bearing, the inventors define

$$S O H = 1 - {\sum }_{i} \frac{1}{{md}_{e , i}^{2 / 3} + b} \qquad ( 8 )$$

Here, m and b are the slope and y-intercept of the least squares best fit line of FIG. 24 with values of m=−1.5(2)×10⁹, and b=4.1(5)×10¹¹, and d_{e,i} is the discharge energy, and the number in parentheses is the standard uncertainty of the last digit shown.

Using Eq. (8), each discharge energy that occurs in the bearing can be summed into the equation, and the SOH can be computed. This value can be used in real time for industrial machine operators to assess the health of their equipment, including if the equipment suffers varying loads at different temperatures.

### Lifetime Prediction for Si and SiC EDM Discharges

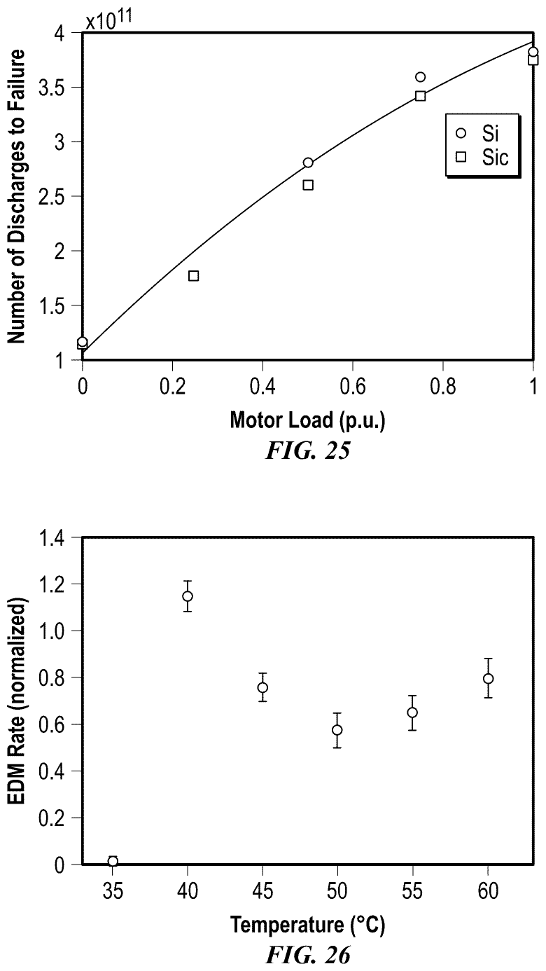

FIG. 24 is a graph of bearing SOH lifetime projections for the Si and SiC inverter at various motor load points of the number of discharges to failure and a motor load with a best fit curve. The line shown is intended to guide the eye. A random series of shaft voltage values are generated for several motor operational points: 0 p.u., 0.25 p.u., 0.5 p.u., 0.75 p.u., and 1 p.u. of rated load. The discharge energy can then be calculated, and the sequence of discharge energies can be fed into Eq. (5) to calculate a bearing's SOH against the number of discharges that have occurred. This can be seen in FIG. 21 for the Si inverter. From FIG. 25, 6306 bearings on a PWM inverter-driven 5 hp motor will last between 225-400 billion discharges, depending on the energy of each discharge. For viewing ease, the results are presented as the motor loading plotted against the number of discharges to failure, as shown in FIG. 25.

From FIG. 25, the computation predicts that bearings will fail faster due to no/light load motor operation (˜115 billion discharges) versus full load operation (˜374 billion discharges). As the load (and temperature) increases, the maximum amplitude of the shaft voltage and bearing current discharges decrease due to a thinner lubricant at higher temperatures, resulting in the probability density functions showing larger energy discharges at no/light load motor operation.

A comparison between Si and SiC devices is also presented in FIG. 25. The results indicate that the differences in inverse Gaussian discharge energy distributions due to pulsed dielectric theory at different motor operating points influence the number of discharges to failure due to SiC operation containing slightly higher discharge values. Conversely, at light loads (<0.25 p.u.), no difference in bearing lifetime is seen due to the shaft voltage and discharge bearing current distribution profile being very similar between Si and SiC inverters.

From FIG. 25, it can be concluded that motor loading contributes to differences in bearing lifetime more than the semiconductor device used. However, this conclusion is obtained by comparing Si and SiC devices independent of inverter switching frequency, which will now be considered.

### Time to Failure

FIG. 26 is a chart of average EDM rates for experiments conducted with standard deviation error bars included. The EDM rate is normalized about the inverter switching frequency, where fₛ=10 KHz for these measurements. To connect the bearing lifetime to a certain duration in the time domain, the switching frequency of the inverter is required. Given the number of discharges to bearing failure, the time to bearing failure can be calculated as follows:

$${t}_{days} = \frac{n}{α {f}_{s}} \cdot \frac{1}{24} \cdot \frac{1}{3600} \qquad ( 9 )$$

Here n is the number of discharges to failure, fₛ is the inverter switching frequency, α is a temperature coefficient that alters the discharge frequency, and the remaining constants are for unit conversion. From FIG. 26, α ranges from ˜0.6-˜ 1.2, where α=1.2 at no/light load conditions where bearings are relatively cool and a thicker lubricating film is present resulting in a smaller number of discharges which have high energy/high damaging effect, through α=0.6 when bearings are at close to an optimal operational temperature from the combination of load and environmental conditions with the lubricant film with a thickness that results in an intermediate rate of discharges with a lowered energy/intermediate damaging effect, to α=0.8 when bearings are relatively warm and a relatively thin film of lubricant results in many more discharges some of which still have sufficient energy to have a damaging effect. This parameter was found empirically by counting the number of discharges that occur on a motor in a specified time frame combined with the expectation of the energy discharge as determined from the discharge energy probability distribution functions. The α parameter therefore accounts for both the number of discharges that occur at each operating temperature relative to the switching frequency and the energy expected to be present/dissipated in each discharge. The α parameter can exceed 1 due to the power electronic inverter having 6 power switching devices that switch at the switching frequency. Therefore, the inverter CM voltage edges that contribute to shaft voltage generation occur at 6fₛ. This means that the maximum number of discharges possible per second is 6fₛ. Further, the α parameter may also exceed 1 because the number of discharges occurring contain/dissipate significantly damaging levels of energy.

Given the relationship of FIG. 26, Table 3 gives examples of lifetime projections for motor bearings at various switching frequencies for no load and full load conditions driven by the SiC inverter. The inventors experienced that as grease ages/deteriorates, the grease becomes thinner with lower dielectric/insulating capability, lowering the shaft voltages/discharge energies.

TABLE 3

| fₛ (kHz) | Motor Load (p.u.) | α | n_{SiC} (billions) | t_{days} | t_{years} |
|---|---|---|---|---|---|
| 2 | 0 | 1.2 | 115.55 | 557 | 1.52 |
| 2 | 1 | 0.8 | 374.13 | 2706 | 7.41 |
| 10 | 0 | 1.2 | 115.55 | 111 | 0.31 |
| 10 | 1 | 0.8 | 374.13 | 541 | 1.48 |
| 20 | 0 | 1.2 | 115.55 | 56 | 0.15 |
| 20 | 1 | 0.8 | 374.13 | 270 | 0.74 |
| 100 | 0 | 1.2 | 115.55 | 11 | 0.03 |
| 100 | 1 | 0.8 | 374.13 | 54 | 0.15 |

The time to failure is linearly proportional to the inverter switching frequency. Changing the load from 0 p.u. to 1 p.u. of rated power increases the lifetime by a factor of 4.86. Therefore, industrial motor operators can expect the longest lifetimes from their bearings when operated at or near full load and with a low switching frequency.

Other and further embodiments utilizing one or more aspects of the inventions described above can be devised without departing from the disclosed invention as defined in the claims. For example, other embodiments can include various parameters, including percentage of graphene nanoplatelets depending on the composition of the original grease formulation, and other variations within the scope of the claims.

The invention has been described in the context of preferred and other embodiments and not every embodiment of the invention has been described. Obvious modifications and alterations to the described embodiments are available to those of ordinary skill in the art. The disclosed and undisclosed embodiments are not intended to limit or restrict the scope or applicability of the invention conceived of by the Applicant, but rather, in conformity with the patent laws, Applicant intend to protect fully all such modifications and improvements that come within the scope of the following claims.

What is claimed is:

1. A bearing, comprising:
an inner race;
an outer race; and
a conductive grease disposed at least between the races and formulated to lower electric discharge energy between the inner race and outer race to a value equal to or below 34 nanojoules sufficiently to avoid damaging the inner race and outer race.

2. The bearing of claim 1, wherein the conductive grease is formulated to lower electric discharge energy to a value equal to or below 17 nanojoules.

3. The bearing of claim 1, wherein the conductive grease is formulated with graphene nanoplatelets.

4. The bearing of claim 1, wherein the conductive grease comprises at least one of a polyolester (POE) oil and a polyalphaolefin (PAO) oil, one or more conductive thickeners of carbon black, graphite, and graphene nanoplatelets, and one or more nonconductive thickeners.

5. The bearing of claim 1, wherein the bearing has a predicted time to failure of formula
$${t}_{days} = \frac{n}{α {f}_{s}} \cdot \frac{1}{24} \cdot \frac{1}{3600}$$
wherein n is the number of discharges to failure, fₛ is the inverter switching frequency, α is a temperature coefficient with a range value between 0.6-1.2, where α=1.2 at no/light load conditions and α=0.8 at full load conditions.

6. A conductive grease comprising graphene nanoplatelets.

7. The conductive grease of claim 6, further comprising at least one of a polyolester (POE) oil and a polyalphaolefin (PAO) oil, at least one conductive thickeners of carbon black and graphite, and at least one nonconductive thickener.

8. The conductive grease of claim 6, wherein the graphene nanoplatelets comprise 0.1 wt % to 20 wt %.

9. The conductive grease of claim 6, wherein the graphene nanoplatelets comprise 5 wt % to 15 wt %.

10. The conductive grease of claim 6, wherein the graphene nanoplatelets comprise a surface area of 2 to 2000 square meters per gram.

11. The conductive grease of claim 10, wherein the graphene nanoplatelets comprise a surface area of 500 square meters per gram.

12. The conductive grease of claim 6, wherein a kinematic viscosity of the conductive grease is 30 to 125 mm² per second at 40° C.

13. The conductive grease of claim 6, v wherein a volume resistivity of the conductive grease is 20 to 650 Ω*cm.

14. The conductive grease of claim 6, wherein the conductive grease has a resistivity value sufficient to lower electric discharge energy between a metallic surface rolling relative to another metallic surface with a grease layer between the surfaces to a value equal to or below 34 nanojoules.

15. A bearing comprising the conductive grease of claim 6.

16. An electrical motor comprising the bearing of claim 6.

17. A system comprising the electrical motor of claim 16 and further comprising at least one device coupled to the motor, wherein at least a portion of the device is configured to be rotated by the motor.

18. A motor comprising a bearing, the bearing comprising a conductive grease formulated to lower electric discharge energy between an inner race and outer race of the bearing to a value equal to or below 34 nanojoules sufficiently to avoid damaging the inner race and outer race.

19. A system compromising a motor and at least one device coupled to the motor, wherein at least a portion of the device is configured to be rotated by the motor, and wherein the motor comprises a bearing comprising a conductive grease formulated to lower electric discharge energy between an inner race and outer race of the bearing to a value equal to or below 34 nanojoules sufficiently to avoid damaging the inner race and outer race.
